(19) United States
(12) Patent Application Publication
(10) Pub. No.: US 2013/0311516 A1
(43) Pub. Date: Nov. 21, 2013

(54) SYSTEMS AND METHODS FOR PROVIDING ENTERPRISE VISUAL COMMUNICATIONS SERVICES

(71) Applicants: Billy Callans, Birmingham, AL (US); Gary York, Hoover, AL (US); Archie Cobbs, Birmingham, AL (US)

(72) Inventors: Billy Callans, Birmingham, AL (US); Gary York, Hoover, AL (US); Archie Cobbs, Birmingham, AL (US)

(73) Assignee: MCKESSON FINANCIAL HOLDINGS, Hamilton (BM)

(21) Appl. No.: 13/076,635

(22) Filed: Mar. 31, 2011

(51) Int. Cl. G06F 17/30

(52) U.S. Cl. 707/798; 707/E17.005

(57) ABSTRACT

Embodiments include systems and methods for providing enterprise visual communications. In one embodiment, a method is provided. The method can include receiving event data from one or more data management systems; based at least in part on the received event data, generating one or more indications for output to a user; based at least in part on the received event data, generating one more expected activities for the user; and generating one or more additional indications corresponding with at least one of the expected activities for output to the user.

### FIELD OF THE INVENTION

Aspects of the invention relate generally to health care, and more particularly, to systems and methods for providing enterprise visual communications services.

### BACKGROUND OF THE INVENTION

Health care settings, such as hospitals and patient care facilities, can involve relatively complex information and work flows. Health care workers can serve in a wide variety of roles and work in many different physical locations across a hospital or other enterprise. Some workers, such as physicians, can be very mobile. As would be expected in such an environment, effective communication among workers can be essential for the overall operation of a hospital or other enterprise to be coherent and productive.

Different users can have different information needs, and often times those needs may require relatively specialized, custom views of information about patient care, patient flow, or resource utilization. These unique needs may be satisfied through a query of an information database or other data storage device which can contain information about the patient care process. The query can provide a set of results as items, such as a set of patients, rooms, or beds. Many conventional data management systems may support such specialized queries of databases and other data storage devices, and may display the query results in a tabular form. In some instances, a particular query may be repeated by a user to periodically update the display to show any changes in the query results.

These types of queries and user interfaces can have drawbacks. For example, query results from these conventional data management systems can be time consuming to read and use. In some instances, relatively important information or other particularly relevant information in a query result may not be readily apparent or may appear later in the query results.

Other conventional solutions, such as visual boards, can be provided by certain data system vendors as add-on systems to an existing enterprise data management system in use at a facility, such as a hospital or patient care facility. Almost all hospitals and patient care facilities use multiple data management systems that may handle different aspects of patient placement, enviromental services, and patient care. Certain conventional visual boards provided by data system vendors may only relate to a particular data management system used in the facility, or may only show current status information. Such solutions may not integrate some or all of the data management systems used by the facility, and may not provide an overall process and compliance picture.

### SUMMARY OF THE INVENTION

Some or all of the above problems may be addressed by certain embodiments of the invention. Embodiments of the invention may include systems and methods for providing enterprise visual communication services. According to one embodiment, a system is provided. The system can include at least one memory for storing computer-executable instructions; and at least one processor configured to access the memory and further configured to execute the computer-executable instructions. The instructions can be operable to receive event data from one or more data management systems; based at least in part on the received event data, generate one or more indications for output to a user; based at least in part on the received event data, generate one more expected activities for the user; and generate one or more additional indications corresponding with at least one of the expected activities for output to the user.

In another embodiment, a method is provided. The method can include receiving event data from one or more data management systems; based at least in part on the received event data, generating one or more indications for output to a user; based at least in part on the received event data, generating one more expected activities for the user; and generating one or more additional indications corresponding with at least one of the expected activities for output to the user.

In yet another embodiment, a further method can be provided. The method can include receiving event data from one or more data management systems, wherein the data management systems comprise at least one of the following: a clinical system, an ADT system, an admission system, an environmental service system, an order and results system, a case management system, a transporter system, and a data system with event data associated with a patient care facility; based at least in part on the received event data, generating one or more indications for output to a user, wherein received event data comprises at least one of the following: a real time event, data associated with a patient, and data associated with a patient care facility; based at least in part on the received event data, generating one more expected activities for the user; generating one or more additional indications corresponding with at least one of the expected activities for output to the user; and outputting the one or more indications and additional indications via a network to a plurality of display devices.

Other systems, methods, apparatuses, features, and aspects according to various embodiments of the invention will become apparent with respect to the remainder of this document.

### BRIEF DESCRIPTION OF THE DRAWINGS

Reference will now be made to the accompanying drawings, which are not necessarily drawn to scale, and wherein:

FIG. 1 illustrates an example system, according to an example embodiment of the invention.

FIG. 2 illustrates an example data flow, according to an example embodiment of the invention.

FIG. 3 illustrates another example visual display for a system and method according to an example embodiment of the invention.

FIG. 4 illustrates another example visual display for a system and method according to an example embodiment of the invention.

FIG. 5 illustrates example icons used in a visual display for a system and method according to an example embodiment of the invention.

FIG. 6 illustrates a flow diagram view of an example predefined workflow for a system and method according to an example embodiment of the invention.

FIG. 7 illustrates an example schematic view of visibility layers for a system and method according to an example embodiment of the invention.

FIG. 8 illustrates another example data flow for a system and method according to an example embodiment of the invention.

FIG. 9 illustrates an example flow diagram of a method according to an example embodiment of the invention.

### DETAILED DESCRIPTION

Embodiments of the invention will be described more fully hereinafter with reference to the accompanying drawings, in which embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those of ordinary skill in the art. Like numbers refer to like elements throughout.

Embodiments of the invention can provide systems and methods for providing enterprise visual communications services. Certain embodiments of the invention can provide interaction with multiple data management systems to visualize information and the status of healthcare processes in a facility, such as a patient care facility. Certain embodiments of systems and methods for enterprise visual communications services can provide at least four levels of service together in a single platform and/or software product. These levels can be (1) real-time data aggregation, (2) a visual display network, (3) process and compliance, and (4) workflow rules.

In one embodiment, event data can be aggregated from multiple data management systems or health care information systems. Data aggregation and/or integration can be managed by certain system embodiments using one or more healthcare industry standards, such as HL7, and can utilize one or more APIs (application program interfaces) for custom interfaces used to gather certain information from certain data management systems and health care information systems. Aggregating real-time event data from multiple systems can capture relevant activities within a particular environment, such as a health care environment or patient care facility, and some or all of the aggregated event data can be immediately visualized in a graphical interface with multiple tiers of indications.

In one embodiment, some or all of the event data can be presented as status updates on an output device in a unqiue visual display algorithm. For example, a visual display alorithm for communication of certain event data can include multiple tiers of indications including a background color and timer, one or more rotating status icons and timers, text based labels, and an organized visual pallette for these components, such as a geospatial arrangement or map, a spreadsheet style grid, or a cross-sectional list of patients and rooms. Certain embodiments of a visual display network can provide certain ransport mechanics to deliver the visual display alorithm to one or more users. In one example, a visual display network can include a set of network connected display devices, handheld computers, and desktop computers that can receive and output the visual display algorithm.

In one embodiment, the event data can be compared to one or more predefined workflows, business rules, and/or health care standards for compliance, and the resulting information can be integrated with or otherwise communicated back to the respective data management systems or health care information systems, or any other interested system or entity. In certain instances, the one or more predefined workflows, business rules, and/or health care standards can be used to interpret event data from multiple data management systems or health care information systems, and relate some or all of the event data to one or more predefined process steps that demonstrate compliance to one or more healthcare standards and provide forecasting of future operations and/or expected activities.

In one embodiment, systems and methods for enterprise visual communications services can permit one or more of the visual display status and process rules to be configured through a workflow rules application program. These visual display status and process rules can be a unique implementation of a set of business rules which can affect the visual display alogithm. The business rules can also control the flow of indications, such as visualization icons, and can define the future flow based on the current state.

In this manner, certain system and method embodiments can provide an overall data integration, process compliance, and visual information package to help a hospital or patient care facility manage patient care needs. One technical effect achieved by certain embodiments of the invention includes providing a multiple layer approach to team coordiantion, loss prevention, quality and safety, and patient throughput. Another technical effect achieved by certain embodiments of the invention is the combination of central data aggregation, a unique visual display algorithm implemented by a visual display network, and a set of predictive workflow rules.

These and other embodiments are described more fully below with reference to the accompanying figures, in which embodiments of the invention are shown.

The term “event data” as used within this specification is defined as an activity during any instance or duration of time. Examples of event data can include, but are not limited to, a patient care activity or event; an activity that occurs in a health care environment; an activity capable of being tracked by a health care information system, such as an admission, transfer or discharge of a patient, or the creation of an order or result associated with a patient; completion of an activity or series of activities; an indication by a user via a client device that particular information should be removed, modified or updated; expiration of an item over a period of time; expiration of a preset time; the presence or absence of a patient or staff member in a certain physical area; a patient's falling; a change in the patient location; and an event notification from a patient monitoring device, such as a heart rate monitor.

The terms “indication” and “indicator”, and their pluralized terms, used within this specification can include, but are not limited to, an icon, a rotating icon, a color, a background color, a safety indicator, a limit, a range, a warning, a statistic, a health status, a date, a time, a timer, a rotating timer, text, contact information, a health-related statistic, a body function, patient care information, a patient care state, a special patient care state, and a patient care activity.

The term “geospatial arrangement” as used within this specification is defined as the organization of data or information relative to a map or map-type view of a particular area.

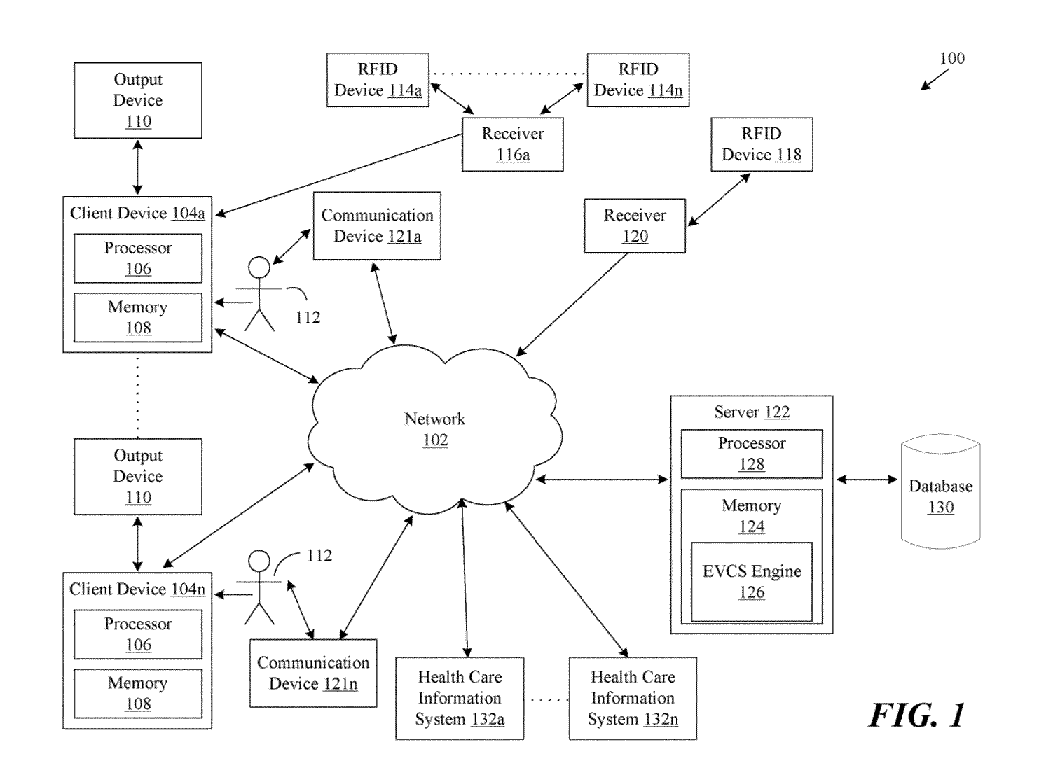

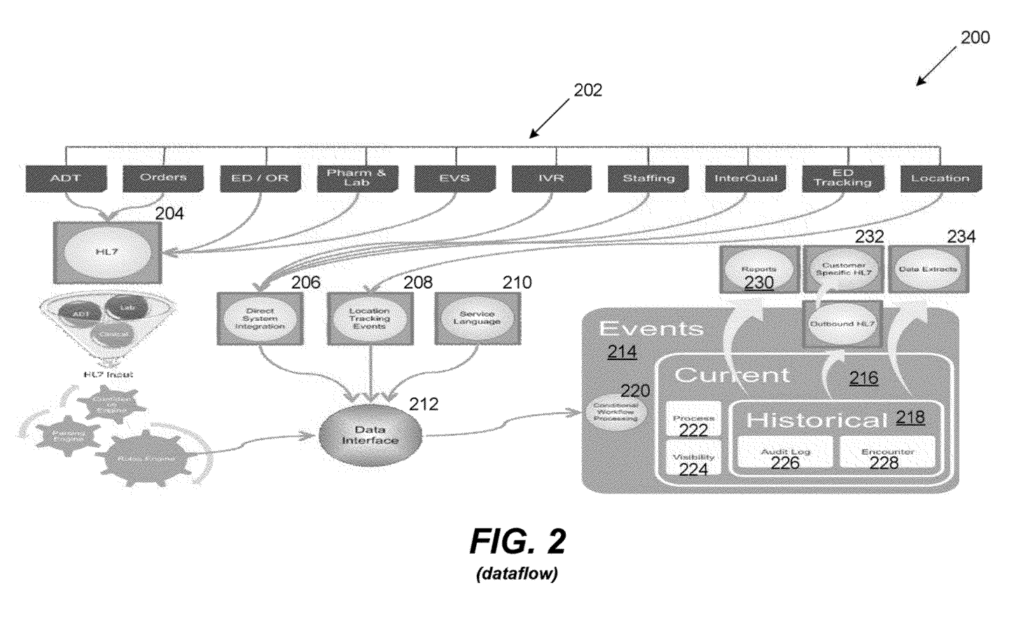

FIG. 1 is an example system in accordance with various embodiments of the invention. The system 100 shown is by way of example, and the system can operate in a variety of environments, such as a health care environment, a patient care facility, or a hospital. Examples of certain aspects of health care environments are shown in FIGS. 2, 3, and 4. Referring back to FIG. 1, a system 100 is shown with a communications network 102 in communication with one or more client devices 104a-104n. Any number of client devices 104a-104n can also be in communication with the network 102. The communications network 102 shown in FIG. 1 can be a wireless communications network or the Internet. Other types of communications networks can be used in accordance with various embodiments of the invention.

Each client device 104a-104n can be a computer or processor-based device capable of communicating with the communications network 102 via a signal, such as a wireless frequency signal or a direct wired communication signal. Each client device, such as 104a-n, can include a processor 106 and a computer-readable medium, such as a random access memory (RAM) 108, coupled to the processor 106. The processor 106 can execute computer-executable program instructions stored in memory 108. Such processors may comprise a microprocessor, an ASIC, and state machines. Such processors comprise, or may be in communication with, media, for example computer-readable media, which stores instructions that, when executed by the processor, cause the processor to perform the steps described herein. Embodiments of computer-readable media include, but are not limited to, an electronic, optical, magnetic, or other storage or transmission device capable of providing a processor, such as the processor 106, with computer-readable instructions. Other examples of suitable media include, but are not limited to, a floppy disk, CD-ROM, DVD, magnetic disk, memory chip, ROM, RAM, an ASIC, a configured processor, all optical media, all magnetic tape or other magnetic media, or any other medium from which a computer processor can read instructions. Also, various other forms of computer-readable media may transmit or carry instructions to a computer, including a router, private or public network, or other transmission device or channel, both wired and wireless. The instructions may comprise code from any computer-programming language, including, for example, C, C++, C#, Visual Basic, Java, Python, Perl, and JavaScript.

Client devices 104a-104n may also comprise a number of external or internal devices such as a mouse, a CD-ROM, DVD, a keyboard, a display, or other input or output devices. As shown in FIG. 1, a client device such as 104a can be in communication with an output device, such as 110. Examples of client devices 104a-104n are personal computers, mobile computers, handheld portable computers, digital assistants, personal digital assistants, cellular phones, mobile phones, smart phones, pagers, digital tablets, pad devices, desktop computers, laptop computers, Internet appliances, and other processor-based devices. In general, a client device, such as 104a, may be any type of processor-based platform that is connected to a network, such as 102, and that interacts with one or more application programs. Client devices 104a-104n may operate on any operating system capable of supporting a browser or browser-enabled application, such as Microsoft® Windows® or Linux. The client devices 104a-104n shown include, for example, personal computers executing a browser application program such as Microsoft Corporation's Internet Explorer™, Netscape Communication Corporation's Netscape Navigator™, and Apple Computer, Inc.'s Safari™.

A user, such as 112, can interact with a client device, such as 104a, via an input device such as a keyboard or a mouse. For example, a user can input information, such as location information associated with a patient, information associated with an indicator of care of a patient, or other information associated with a particular patient, via the client device 104a by keying text via a keyboard or inputting a command via a mouse, or using a stylus or using a bare finger. In another example, a user can input a user query for patient care information via the client 104a by keying text via a keyboard or inputting a command via a mouse. In one embodiment, a user 112 can input one or more commands via a client device 104a to select one or more desired items or other information for display via an output device, such as 110. A user 112a can also input one or more commands via a client device 104a to configure a graphical user interface for an output device, such as selecting a desired geospatial arrangement of items or other information for the graphical user interface.

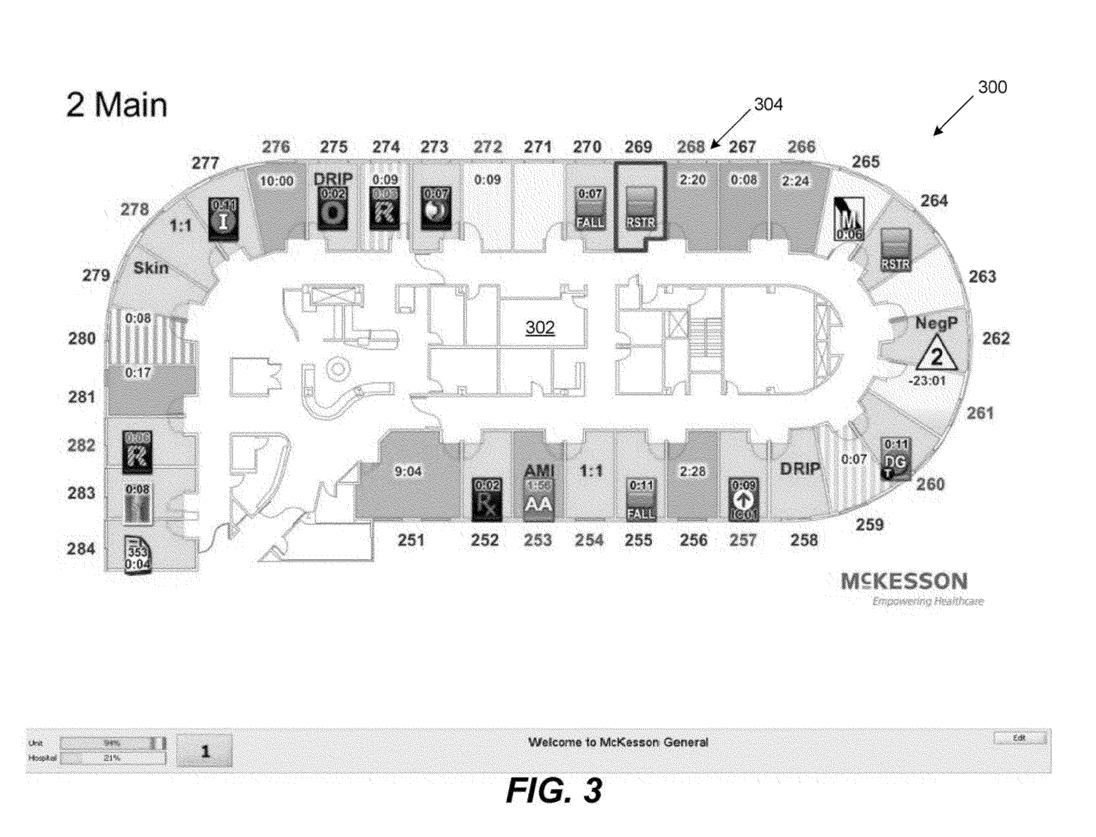

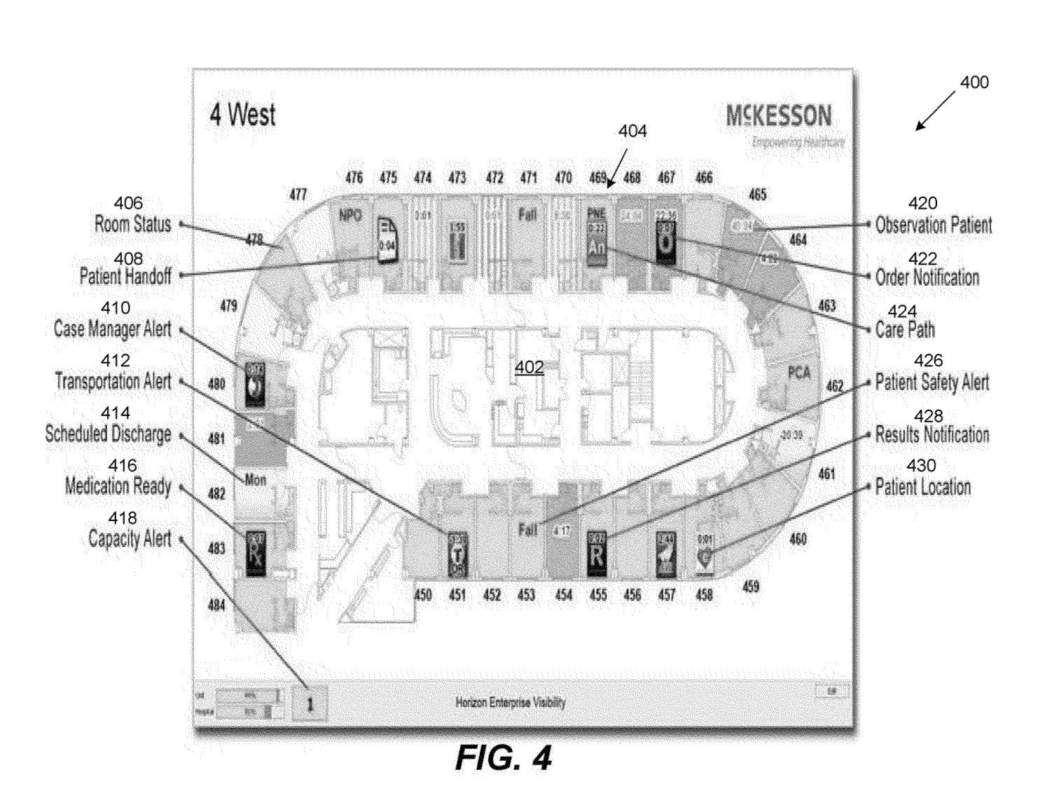

A user such as 112 can receive output, such as a query response with patient care information or other information associated with a particular patient information, from an output device, such as 110, via a client device. In one embodiment, information such as location information associated with a patient and a status of care for a patient can be displayed on an output device 110. One suitable output device is a display device capable of displaying information in a geospatial arrangement on a graphical user interface. Another suitable output device is a McKesson™ patient care communication display board capable of displaying location information associated with a patient, an indicator of care of a patient, or other patient process care information in a map, geospatial-type view, table, or grid-type view. Other types of output devices can include, but are not limited to, private-type displays, public-type displays, plasma displays, LCD displays, touch screen devices, and projector displays on cinema-type screens. In some embodiments, the Scalable Vector Graphics (“SVG”) standard for describing graphical information, or a similar suitable standard or technique, may be utilized as part of the graphical rendering process. Examples of a suitable graphical user interface for an output device, such as 110, are shown and described below in FIGS. 3 and 4.

In one embodiment, multiple output devices such as public-type displays or flat screen monitors can be mounted in a health care environment, such as in rooms, hallways, on doors, in central monitoring areas, or other areas where users or health care personnel may work, be stationed, or otherwise desire information associated with a patient's location or patient's health care status. In other embodiments, an output device such as private-type display or a computer display monitor can be connected to or associated with a client device, such as a handheld portable computer device or a desktop personal computer (PC).

In the embodiment shown in FIG. 1, a device, such as 114a, capable of providing location information associated with a patient can be in communication with a client device, such as 104a. A corresponding receiver, such as 116a, capable of receiving location information associated with a patient can interface or otherwise facilitate communication between the device 114a and the client device 104a. Multiple devices, such as 114a-114n, capable of providing location information associated with respective patients can also be in communication with a client device, such as 104a, via the same receiver, such as 116a, or any number of other receivers. Other receivers, such as 116n, capable of receiving location information associated with a patient can interface or otherwise facilitate communication between any number of devices capable of providing location information associated with respective patients and a client device. A suitable device capable of providing location information associated with a patient can be a radio frequency identification device (RFID), and a suitable receiver capable of receiving location information associated with a patient can be a RFID reader. Other types of devices and technologies capable of providing location information associated with a patient can be used with other embodiments of the invention, including, but not limited to, passive-type RFID, active-type RFID, wireless, infrared, global positioning satellite (GPS)-type devices or other devices capable of providing location information associated with a patient or otherwise facilitating determination of a location associated with a patient, staff member, or piece of medical equipment.

In at least one embodiment, a device capable of providing location information associated with a patient, and a corresponding receiver capable of receiving location information associated with a patient can communicate with a client device via a network. For example as shown in FIG. 1, device 118 and receiver 120 can communicate with client device 104a via the network 102. In another embodiment, a device capable of providing location information associated with a patient can communicate with both the network 102 and one or more client devices 104a-104n, either with or without a corresponding receiver capable of receiving location information associated with a patient. In some instances, a receiver capable of receiving location information associated with a patient can be incorporated into or otherwise associated with a client or another device associated with a network. In any of these instances, a device capable of providing location information associated with a patient and a corresponding receiver capable of receiving location information associated with a patient can communicate the location information to a remote location via a network, such as 102.

In one embodiment, any type of wireless location tracking technology, such as active RFID, can be used to provide real time location information about one or more patients' locations in a health care environment. Such locations can be tracked automatically by an EVCS engine, such as 126 in FIG. 1 and described below, via the wireless location tracking technology as each patient moves throughout a health care environment, such as a hospital, floor, or room.

In one embodiment, each client device, such as 104a-104n, can be associated with a unique identifier. Examples of suitable identifiers are serial numbers, Ethernet MAC addresses, IP addresses, numbers generated via random and/or pseudo-random algorithms etc. A database, such as 130 in FIG. 1 and described below, or other data storage device can store the unique identifiers for subsequent retrieval. In this manner, the system 100 can record the location of a client device, such as 104a or a desktop computer, so that the display configuration for an associated output device, such as 110, can be changed based on the location of the client device or desktop computer. For example, a client device or desktop computer on a third floor of a building in a health care environment may only be able to display information about patients on that particular floor. By associating a unique identifier with each client device or desktop computer, the system 100 can track the location of each client device or desktop computer, and in particular mobile client devices, to support dynamic information display on the associated output device based on the current location of the particular client device.

The system 100 can also include a server 122 in communication with the network 102. The server 122 shown can include memory 124 and an enterprise visual communication services (EVCS) application program, also known as an EVCS engine 126. The EVCS engine 126 and server device 122 can cooperate, or otherwise operate individually, to aggregate event data from one or more data management systems or health care information systems, such as 132a-132n, to receive information, such as event data or real time events associated with one or more patient care processes as well as indicators of care of one or more patients.

Examples of event data can include, but are not limited to, a patient care activity or event; an activity that occurs in a health care environment; an activity capable of being tracked by a health care information system, such as an admission, transfer or discharge of a patient, or the creation of an order or result associated with a patient; completion of an activity or series of activities; an indication by a user via a client device that particular information should be removed, modified or updated; expiration of an item over a period of time; expiration of a preset time; the presence or absence of a patient or staff member in a certain physical area; a patient's falling; a change in the patient location; and an event notification from a patient monitoring device, such as a heart rate monitor.

In certain embodiments, the EVCS engine 126 and server device 122 can integrate with and can communicate with other information systems in a health care environment to receive such information. In any instance, the received event data, real time events, and indications can be stored in a database 130 or other data storage device to support real time and dynamic updating of information displayed on some or all of the output devices 110. As shown in FIG. 1, an information system such as one or more data management systems or health care information systems, such as 132a-132n, can communicate with the server 122 and EVCS engine 126 via the network 102. In one embodiment, communications by the server 122 and EVCS engine 126 with other suitable data management systems or health care information systems, such as 132a-132n, can be based on an industry standard HL7 communication model. In another embodiment, communications by the server 122 and EVCS engine 126 with other suitable data management systems or health care information systems, such as 132a-132n, can be through one or more APIs. In yet another embodiment, a custom integration of the server 122 with other suitable data management systems or health care information systems, such as 132a-132n, can achieve similar results to an industry standard HL7 communication model. Examples of suitable data management systems or health care information systems the server device 122, the EVCS engine 126, and other components of the system 100 can aggregate event data from, integrate with, or otherwise communicate with can include, but are not limited to, an ADT (admission, discharge, and transfer) system, an ordering system, an ED/OR-type (emergency/operating room) system, an EVS-type (enterprise vocabulary system) system, an IVR (interactive voice response) system, a staffing system, an InterQual-type system, an ED tracking system, a location system, a result reporting system, a lab-type system, a pharmacy-type system, a radiology-type system, a transcription-type system, an environmental services-type system, and a transportation-type system.

Information associated with various indicators of care associated with one or more patients can be received by the server 122 and EVCS engine 126 via the network 102 from one or more client devices 104a-104n, the database 130 or other data storage devices, and from one or more data management systems or health care information systems 132a-132n. In one embodiment, information associated with an indicator of care of a patient can be input by a user 112, such as an attending physician, via a client device 104a, such as a handheld portable computer or desktop computer. The information can be received as one type of event data by the server 122 via the network 102 for processing by the EVCS engine 126 or storage by the database 130 or other data storage device. In another embodiment, information associated with an indicator of care associated with one or more patients can be received or otherwise obtained as another type of event data from a data management system or health care information system, such as 132a-132n, database 130, or other data storage device or information source. Further, other event data associated with a patient care or health care environment can be received or otherwise obtained as another type of event data from a data management system or health care information system, such as 132a-132n, database 130, or other data storage device or information source. In any instance, the EVCS engine 126 can ultimately receive or obtain, and aggregate some or all of such information as event data from such sources via the server 122 and the network 102.

In one embodiment, an EVCS engine 126 can receive location information associated with a patient from a device capable of providing location information associated with a patient, such as a RFID. The EVCS engine 126 can receive this information as another type of event data, correlate the location information with any other information and event data, such as an indicator of care of a particular patient, and facilitate the display of information on one or more output devices, such as 110.

In one embodiment, an EVCS engine 126 can permit a user, such as 112, to transmit a query for patient care information. For example, the EVCS engine 126 can provide functionality via a client device, such as 104a, to allow a user 112 to transmit a query to obtain information associated with a particular patient. The EVCS engine 126 can receive and process the query to generate a query response, for instance, a location associated with the patient and an indicator of care of the patient. The EVCS engine 126 is further capable of facilitating a geospatial arrangement and graphical display of information associated with a particular patient on an output device such as 110, for example, location information associated with the patient and an indicator of care of the patient.

Using some or all of the received event data, certain embodiments of an EVCS engine, such as 126, can facilitate a display of information, based at least in part on the received event data, in an organized arrangement on an output device, such as 110. For example, the EVCS engine 126 can generate one or more indications, based at least in part on the received event data, for display on one or more output devices, such as 110. In this example, the EVCS engine 126 can generate graphical representations of various event data information on a graphical user interface for an output device, such as 110. An indication can include, but is not limited to, an icon, a rotating icon, a color, a background color, a safety indicator, a limit, a range, a warning, a statistic, a health status, a date, a time, a timer, a rotating timer, text, contact information, a health-related statistic, a body function, patient care information, a patient care state, a special patient care state, and a patient care activity.

Furthermore, an organized arrangement can include, but is not limited to, a scaled geospatial arrangement corresponding with a physical location, a grid, and a list. For example, a scaled geospatial arrangement corresponding with a physical location can be a floor plan of a hospital or patient care facility showing respective patient rooms in approximate relation to each other.

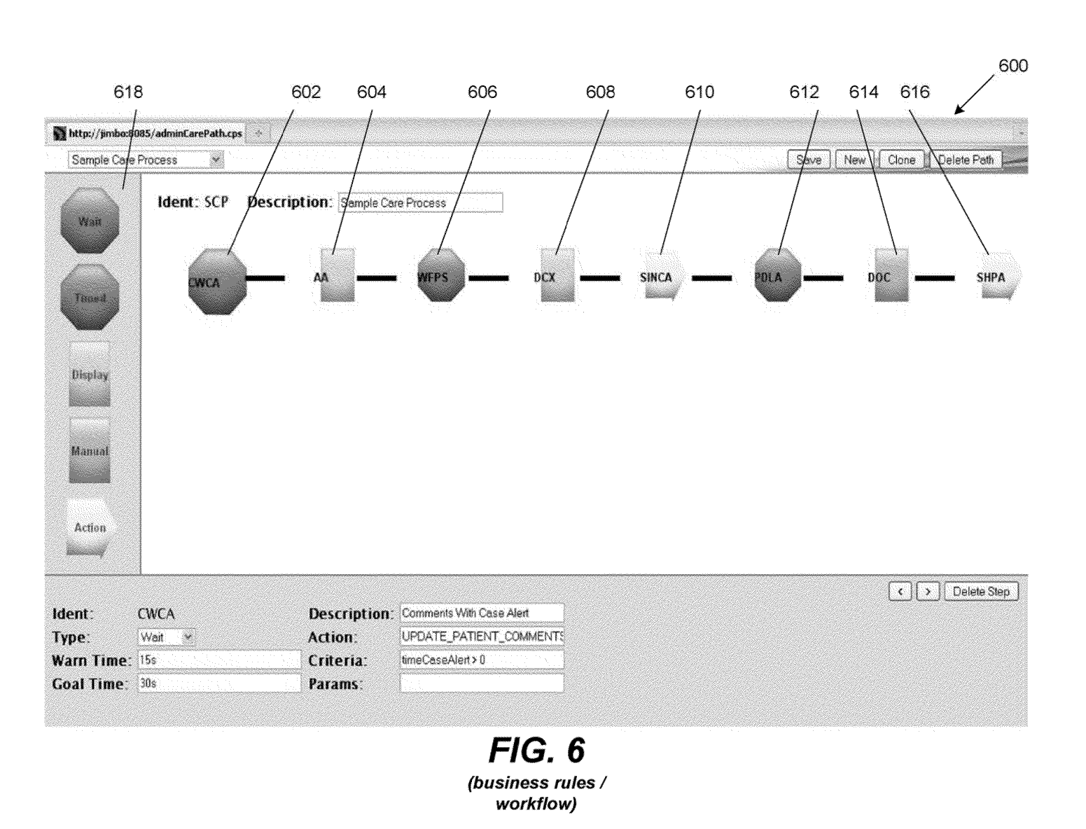

In the embodiment shown in FIG. 1, an EVCS engine 126 can also analyze some or all of the received event data, and compare certain event data to at least one predefined workflow, business rule, or health care standard. A predefined workflow can be a set of operations for a particular activity associated with patient care or a facility. An example predefined workflow is shown and described with respect to FIG. 6. In any instance, the EVCS engine 126 can compare certain event data to the predefined workflow, and based on the comparison, determine one or more expected activities.

A business rule can be a statement with at least one threshold, limit, or definable measure, and at least one resulting action if a threshold, limit, or definable measure is or is not met, exceeded, or otherwise satisfied. The EVCS engine 126 can compare certain event data to a business rule, and determine whether a threshold, limit, or definable measure is met, exceeded, or otherwise satisfied. Based on the comparison, the EVCS engine 126 can identify one or more expected activities. For example, a suitable threshold in an example workflow with an aspirin arrival as an event can be a threshold corresponding with the number of aspirin administered to a patient, such as 2. If the number of aspirin administered is tested and found to meet, exceed, or otherwise satisfy the threshold, such as 2, then one or more particular resulting actions, such as beginning a timer for time elapsed since delivery of the aspirin to the patient, according to at least one business rule can be implemented.

Activities can be workflow process steps, and a threshold related to one or more steps within the workflow process can be satisfied by event data. Each activity can have one or more conditional criteria or conditions that define what is needed to satisfy them. There can be multiple conditional criteria or conditions within a single activity. An expected activity or resulting action can be event data that is defined for the respective activity and that satisfies that respective activity. The expected activity or resulting action can correspond to the respective activity for which the threshold is met, exceeded, or otherwise satisfied.

A health care standard can be a standard specified by a governing organization, government, or other administrative or certification entity with at least one measurable characteristic. The EVCS engine 126 can compare certain event data to a health care standard, and determine whether a measurable characteristic is met, exceeded, or otherwise satisfied. In any instance, based on the comparison, the EVCS engine 126 can identify one or more expected activities.

In the above manner, an EVCS engine, such as 126, can generate one or predictions of expected activities needed for completion of a predefined workflow, generate one or more predictions of expected activities based on whether a business rule is satisfied, and generate one or more predictions of expected activities based on whether a health care standard is satisfied.

In one embodiment, when new or changed information, such as new event data, is received by the EVCS engine 126, the EVCS engine 126 can update one or more previously generated indications on an output device. For example, when new event data is received by the EVCS engine 126, one or more indications on a graphical user interface for an output device, such as 110, can, in real time, be updated, revised, deleted, or added by displaying some or all of the new and/or changed information as respective indications. In one example, new or changed event data can be received by the EVCS engine 126 from a device capable of providing location information associated with a patient or a user input of an indicator of care of a patient. The EVCS engine 126 can update the patient's location information on a graphical user interface for an output device, such as 110, in real time by displaying some or all of the new or changed location information.

In addition, the EVCS engine 126 is capable of displaying any number of items in a particular environment, and formatting the items in any type of view provided on a graphical user interface for an output device, such as a map, geospatial-type view, grid-type view, or list-type view. For example, medical equipment, fixtures, instruments, machines, and other health care and/or patient care objects can be illustrated on a graphical interface for an output device, such as 110, in conjunction with previously generated indications of event data.

In any instance, a user can obtain and monitor selected patient care information, such as event data, in a geospatial arrangement on a graphical user interface for an output device, such as 110; view one or more expected activities associated with patient care; and view any new or changes, in real time, to the information, event data, and/or expected activities on the graphical user interface as needed.

Similar to the client devices 104a-104n, the server device 122 shown comprises a processor 128 coupled to a computer-readable memory 124. The server device 122 can be in communication with a database, such as 130, or other data storage device. The database 130 can receive and store data from the server 122, or from a client device, such as 104a, via the network 102. Data stored in the database 130 can be retrieved by the server 122 or client devices 104a-104n as needed.

Server device 122, depicted as a single computer system, may be implemented as a network of computer processors. Examples of a server device 122 are servers, mainframe computers, networked computers, a processor-based device, and similar types of systems and devices. Client processor 106 and the server processor 128 can be any of a number of computer processors, such as processors from Intel Corporation of Santa Clara, Calif and Motorola Corporation of Schaumburg, Ill. The computational tasks associated with rendering the graphical image could be performed on the server device(s) and/or some or all of the client device(s).

The system 100 shown in, and described with respect to, FIG. 1 is provided by way of example only. Numerous other systems, operating environments and components, system architectures, and device configurations are possible. Accordingly, embodiments of the invention should not be construed as being limited to any particular system, operating environment or component, system architecture, or device configuration.

FIG. 2 illustrates an example data flow, according to an example embodiment of the invention. The data flow 200 illustrates multiple data management systems and/or health care information systems, such as 202, in communication with various sub-interfaces 204, 206, 208, 210. Each of the data management systems 202 can generate and provide event data, which is ultimately transmitted to central data interface 212, which can be associated with an EVCS engine, such as 126 in FIG. 1. Each of the sub-interfaces 204, 206, 208, 210 can assist in receiving, translating, formatting, and obtaining the event data. For example, sub-interface 204 can be a HL7 interface, which can facilitate communications using industry standard HL7 communications with certain data management systems, such as an ADT system, an orders system, an ED/OR system, a pharmacy-type system, a laboratory-type system, and an EVS system. Sub-interface 206 can be a direct system integration interface, which may be needed to directly integrate a third party data management system, such as an IVR system, a staffing system, an InterQual-type system, and an ED tracking system, to a server, such as 122 in FIG. 1, operating in conjunction with a EVCS engine 126. Sub-interface 208 can be a location tracking event interface 208, which can facilitate communications with a location-type data management system. Finally, sub-interface 210 can be a service language interface or API (application program interface), which may be customized to communicate with a particular data management system, health care information system, or other application program.

In any instance, each of the sub-interfaces 204, 206, 208, 210 communicate event data to the central data interface associated with an EVCS engine, such as 126, where the event data can be aggregated for subsequent processing by the EVCS engine 126. The central data interface 126 can transmit the aggregated event data to one or more application or program layers associated with the EVCS engine 126, such as an event layer 214, a current event layer 216, and a historical event layer 218. For example, the EVCS engine 126 can include program code associated with conditional workflow processing 220, which can analyze the aggregated event data against one or more predefined workflows, business rules, or health care standards. Aggregated event data is generally processed by the program code associated with conditional workflow processing functionality 220. In certain instances, aggregated event data may be transmitted to or otherwise processed by a current event layer 216, which can analyze the aggregated event data and generate one or more expected activities for output via a visual display algorithm. The current event layer 216 can include program code associated with process functionality 222 and visibility functionality 224 to facilitate these analyses. In certain instances, aggregated event data may be transmitted to or otherwise processed by a historical layer 218, which can analyze the aggregated event data and generate one or more reports, data extracts, or direct responses to a data management system or health care information system. The historical layer 218 can include program code associated with audit log functionality 226 and encounter functionality 228. Using event data analyzed and processed by the historical layer 218, one or more reports 230, data extracts 232, or direct responses 234 (via HL7 communications or other APIs) can be generated. In certain embodiments, the event layer 214 and current event layer 216 can generate one or more reports, data extracts, or direct responses to a data management system or health care information system.

Thus, as shown in FIG. 2, the example data flow 200 can facilitate analyzing activity generated from data management systems and/or health care information systems, such as an admission system, order and results system, clinical system, enviromental services system, transport system, case management system, and others, and can integrate some or all received event data into a database, such as 130, associated with an EVCS engine, such as 126. This event data can be used by the visibility functionality, such as 224, to communicate status. This event data can also be used by the process functionality 222 to predict one or more expected activities and to communicate those expected activities to the visibility functionality 224. All of this information can be made available outside the visibility functionality 224.

The data flow 200 shown in, and described with respect to, FIG. 2 is provided by way of example only. Numerous other data flows, operating environments and components, system architectures, and device configurations are possible. Accordingly, embodiments of the invention should not be construed as being limited to any particular data flow, operating environment or component, system architecture, or device configuration.

FIG. 3 illustrates an example visual display for a system and method according to an example embodiment of the invention. In this example, an output device, such as 110 in FIG. 1 or a display monitor, can facilitate display of a graphical user interface 300 shown. Based at least in part on aggregated received event data, an EVCS engine, such as 126 in FIG. 1, can generate the graphical user interface 300 with a scaled geospatial arrangement 302 of various information, such as graphical information, associated with a patient, including location information associated with a patient and one or more indications 304 and/or indicators of care of a patient. For example, the graphical user interface can include a scaled map or geospatial view of a health care environment, such as a hospital or patient care facility. A scaled map or geospatial view can be divided, for example, into multiple areas that represent the relative location of rooms in a hospital. One or more areas within or adjacent to the scaled map or geospatial view can display graphical information associated with a status of a particular patient, such as location information associated with a patient or an indicator of care of a patient. Such areas within the map or adjacent to the map can include other graphical information and indications 304 including, but not limited to, text, icons, rotating icons, graphical elements, colors, timers, rotating timers, animation, or any combination thereof. In other embodiments, different combinations of graphical information and indications, and orientations of a scaled geospatial arrangement can be displayed on a graphical user interface.

FIG. 4 illustrates another example visual display for a system and method according to an example embodiment of the invention. Similar to 300 in FIG. 3, the graphical user interface 400 or visual display can be generated by an EVCS engine, such as 126, for an output device, such as 110. Further similar to 300 in FIG. 3, the graphical user interface 400 includes a scaled geospatial arrangement 402 of various information, such as graphical information, associated with a patient, including location information associated with a patient and one or more indications 404 and/or indicators of care of a patient. Example indications shown in FIG. 4 include the following: room status 406, patient handoff 408, case manager alert 410, transportation alert 412, scheduled discharge 414, medication ready 416, capacity alert 418, observation patient 420, order notification 422, care path 424, patient safety alert 426, results notification 428, and a patient location 430. In other embodiments, different combinations of graphical information and indications, and orientations of a scaled geospatial arrangement can be displayed on a graphical user interface.

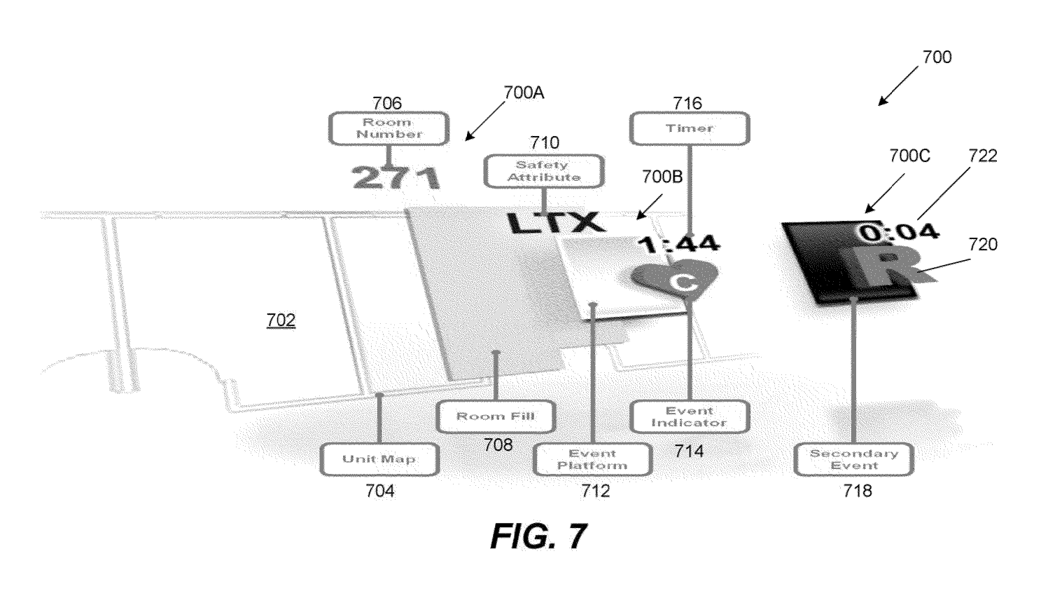

In certain embodiments, including the embodiments 300, 400 shown in FIGS. 3 and 4, the graphical user interfaces can include multiple layers of visual indications as generated by a visual display algorithm associated with an EVCS engine, such as 126 in FIG. 1. An example visual display algorithm is described below with respect to FIG. 7.

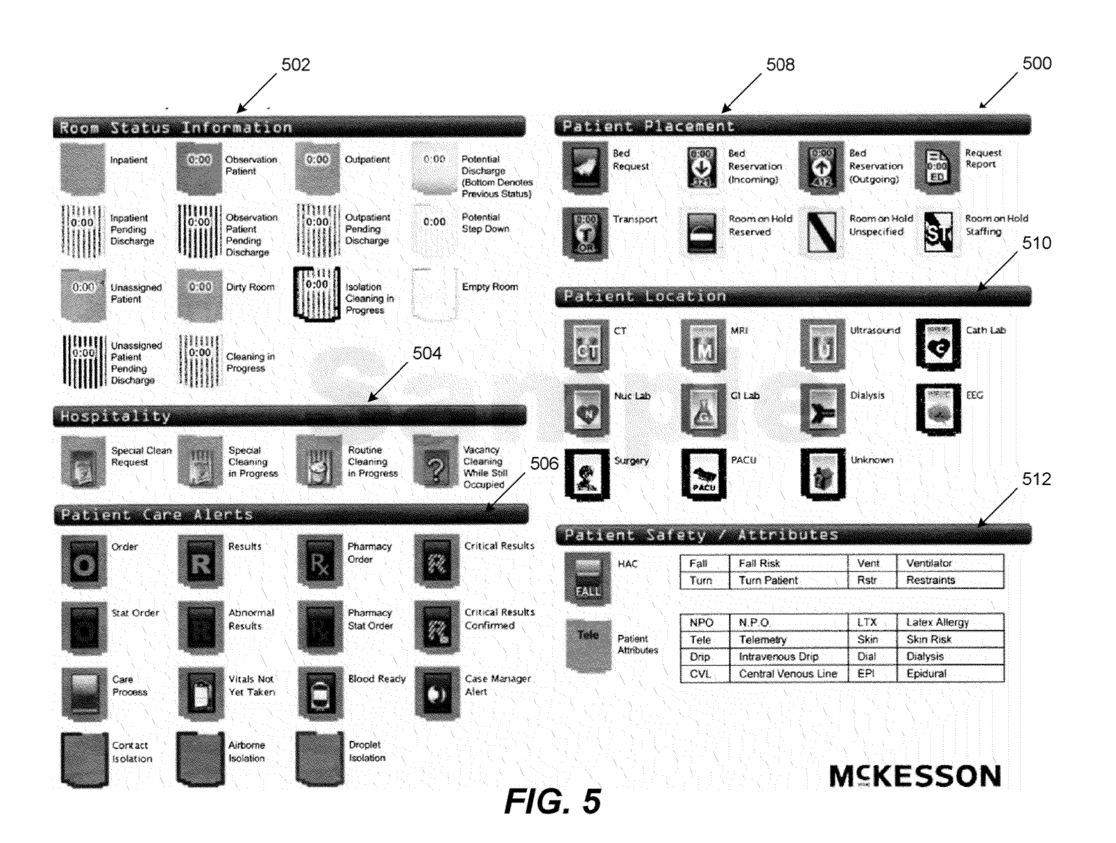

FIG. 5 illustrates example icons used in a visual display for a system and method according to an example embodiment of the invention. In this example, an EVCS engine, such as 126 in FIG. 1, can generate one or more of the indications or icons shown in the table 500, and display the indications or icons on a graphical user interface, similar to 300, 400 in FIGS. 3 and 4, with a scaled geospatial arrangement 302 of various information, such as graphical information, associated with a patient, including location information associated with a patient and one or more indicators of care of a patient. Example indications or icons shown in FIG. 5 include room status indications 502, hospitality indications 504, patient care alerts 506, patient placement indications 508, patient location indications 510, and patient safety/attributes indications 512. In particular, room status indications can include, but are not limited to, indications corresponding with inpatient, observation patient and timer, outpatient and timer, potential discharge and timer with previous status, inpatient pending discharge and timer, observation patient pending discharge and timer, outpatient pending discharge and timer, potential step down and timer, unassigned patient and timer, dirty room and timer, isolation cleaning in progress and timer, empty room, unassigned patient pending discharge and timer, and cleaning in progress and timer. Hospitality indications can include, but are not limited to, special clean request, special cleaning in progress, routine cleaning in progress, and vacancy cleaning while still occupied. Patient care alerts can include, but are not limited to, order, results, pharmacy order, critical results, stat order, abnormal results, pharmacy stat order, critical results confirmed, care process, vitals not yet taken, blood ready, case manager alert, contract isolation, airborne isolation, and droplet isolation. Patient placement indications can include, but are not limited to, bed request, bed reservation (incoming) with timer and room number, bed reservation (outgoing) with timer and room number, request report with timer and department name, transport with timer and department name, room on hold reserved, room on hold unspecified, and room on hold staffing. Patient location indications can include, but are not limited to, CT, MRI, ultrasound, cath lab, nuc lab, GI lab, dialysis, EEG, surgery, PACU, and unknown. Patient safety/attributes indications can include, but are not limited to, HAC such as fall risk, turn patient, ventilator, and restraints; and patient attributes such as N.P.O., telemetry, intravenous drip, central venous line, latex allergy, skin risk, dialysis, and epidural.

In other embodiments, different graphical information and indications, colors, icons, and other visual features of indications can be displayed in a scaled geospatial arrangement for display on a graphical user interface or output device.

FIG. 6 illustrates a flow diagram view of an example predefined workflow for a system and method according to an example embodiment of the invention. In the embodiment shown in FIG. 6, an example predefined workflow 600 can be generated and stored by a user operating a client device, such as 104a in FIG. 1, or may be a previously generated and stored object or file associated with an EVCS engine, such as 126. One or more predefined workflows can be stored by the EVCS engine 126, in a database 130 associated with an EVCS engine or server, or any client device or data storage device. In any instance, a predefined workflow can include one or more steps or operations in a workflow process. For example, as shown in FIG. 6, an example care process can be a series of 8 sequential steps or operations. In other embodiments, fewer or greater numbers of steps of operations can comprise a workflow process. Operation 602 can be an operation associated with comments with case alert (CWCA), operation 604 can follow operation 602, and so on. Each of the operations 602, 604, 606, 608, 610, 612, 614, 616 can be associated with a different type of step or operation, such as wait, timed, display, manual, or action, as listed in 618. Each type of step or operation may have a unique shape and/or color. In any instance, the workflow 600 can be defined to include some or all the steps or operations of a particular workflow process. An EVCS engine, such as 126, can compare received event data to one or more predefined workflows, as illustrated in FIG. 6, to determine or otherwise generate one or more indications and/or expected activities, based at least in part on the received event data. More detailed examples of a workflow and associated steps or operations with respect to an embodiment of the invention are provided below.

In other embodiments, different steps, operations, colors, shapes, icons, graphical information and indications, and other visual features of indications can be included in a predefined workflow.

FIG. 7 illustrates an example schematic view of visibility layers for a system and method according to an example embodiment of the invention. The visibility layers 700 can include one or more layers generated by an EVCS engine, such as 126 in FIG. 1, for a graphical user interface 702 of an output device, such as 110 in FIG. 1. In this example, the layers 700 can include a unit map 704, room number 706, a room fill 708, a safety attribute 710, an event platform 712, an event indicator 714, a timer 716, a secondary event 718, a secondary event indicator 720, and a secondary event timer 722. Using one or more visual display algorithms, the EVCS engine 126 can generate one or more indications associated with received event data from one or more data management systems and/or health care information systems, such as 132a-132n in FIG. 1. For example, a suitable visual display algorithm can generate a unit map 704 on a graphical user interface 702, wherein the unit map 704 represents a scaled geospatial arrangement of a patient care facility. The example visual display algorithm can, in a first layer 700A, generate a room number 706 a suitable room fill 708 such as a color or pattern, and a safety attribute 710 associated with a patient in a particular location such as a room. In a second layer 700B, on top of the first layer 700A, the example visual display algorithm can, in response to received event data, generate an event platform 712 with an event indicator 714 and a timer 716. In a third layer 700C, on top of the first layer 700A and second layer 700B, the example visual display algorithm can, in response to received event data, generate a secondary event 718 or secondary event platform with a secondary event indicator 720 and a secondary event timer 722.

In other embodiments of the invention, other indications, colors, patterns, configurations, and combinations of elements shown in FIGS. 3, 4, 5, and 7 can be generated, selected, or otherwise used by a visual display algorithm to represent event data and/or expected events on a graphical user interface, such as 702. Other visual display algorithms in accordance with certain embodiments of the invention can use fewer or greater numbers of layers, elements, and indications.

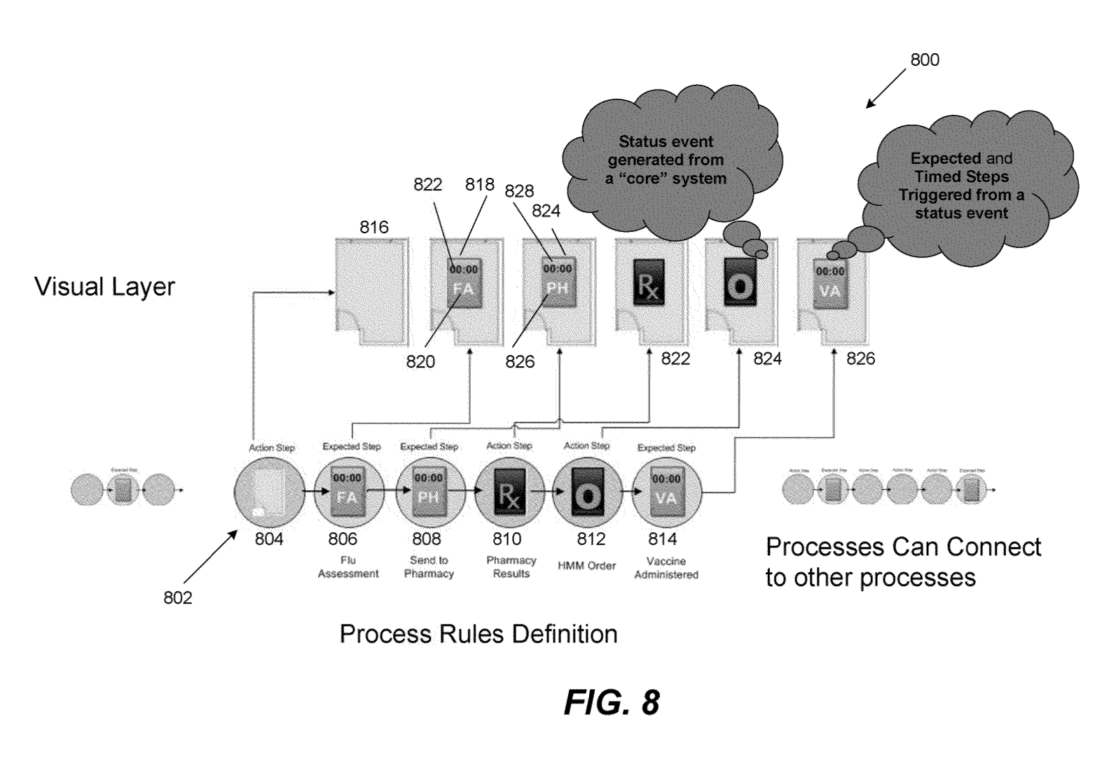

FIG. 8 illustrates another example data flow for a system and method according to an example embodiment of the invention. The data flow 800 shown in FIG. 8 illustrates an example coordination of a predefined workflow 802 and a visual display algorithm, similar to one described above in FIG. 7, by an EVCS engine, such as 126 in FIG. 1. Beginning at 804, a series of steps or operations, such as 806, 808, 810, 812, 814 for a predefined workflow 802 can be illustrated by way of example. Each step or operation in the predefined workflow 802 can be an action step or expected step. As the EVCS engine 126 receives event data from one or more data management systems and/or health care information systems, such as 132a-132n in FIG. 1, the EVCS engine 126 can refer to one or more business rules associated with each step or operation of the predefined workflow 802.

For example, as the EVCS engine 126 processes the event data against one or more business rules for the first step or operation 804, one or more indications can be generated. In this example, an indication such as a room fill 816, similar to 708, for a particular location on a unit map can be generated by the EVCS engine 126 implementing the visual display algorithm. Subsequently, as the EVCS engine 126 processes the same and/or additional event data against one or more business rules, the expected second step or operation 806 and the expected third step or operation 808 in the predefined workflow 802 can trigger generation of indications, such as an event platform 818, a flu assessment event indicator 820, and timer 822. The expected third step or operation 808 may correspond to generating an indication, such as an event platform 824 with a send to pharmacy indicator 826 and timer 828. Subsequently, as the EVCS engine 126 processes the same and/or additional event data against one or more business rules associated with the fourth step or operation 810, one or more indications, such as an event platform with a pharmacy results icon, can be generated by the EVCS engine 126 implementing the visual display algorithm. Subsequently, as the EVCS engine 126 processes the same and/or additional event data against one or more business rules associated with the fifth step or operation 812, one or more indications, such as an event platform with a status O icon 828, can be generated by the EVCS engine 126 implementing the visual display algorithm. Finally, as the EVCS engine 126 processes the same and/or additional event data against one or more business rules, the sixth step or operation 814 of an expected event in the predefined workflow 802 can trigger generation of indications, such as an event platform with a vaccine administered icon 830 and a timer 832.

The above example predefined workflow and visual display algorithm are illustrated and described by way of example only, and other embodiments may include similar or different business rules, sequences of steps or operations, and indications. One will recognize that fewer or greater steps or operations in a predefined workflow can exist, and that a predefined workflow may connect with other predefined workflows operating or executing in conjunction with and/or sequentially with the present predefined workflow. Example predefined workflows, business rules, and indications are as follows:

### Example #1

### Workflow with Nurse Order

In this example, an order event can be received from a clinical order system (e.g., an order for medication, lab work, or clinical procedure). This type of event can trigger an indication or visual icon to appear on at least one output device in at least one of the visual display formats (geospatial, grid style, or list) representing the current status of the order. The order event can also be compared to a predefined workflow and/or a set of business rules. For instance, if there is a business rule for the order event, evaluation of the business rule against the order event can trigger the display of an indication or visual icon representing the next step or operation that may be needed based on information from the order event. For example, a business rule for an order for medication, such as aspirin, can trigger the display of an indication such as a timer indicating the time elapsed since placing the order for medication. Also, if the current or prior business rule has already applied a previous indication or icon signaling the need for this order event, then the presence of the order event can trigger the removal of that prior indication or icon since the receipt of the event satisfies the prior indication or icon.

### Example #2

### Workflow with Aspirin Arrival

In this example, a patient with chest pain can be flagged for receiving aspirin within a particular time limit after the patient's arrival. Aspirin can be a trigger from a result event, such as identifying or otherwise diagnosing a patient with chest pain. In any instance, a result event can be received from a clinical result system. The result event can trigger an indication or visual icon to appear on at least one output device in at least one of the visual display formats (geospatial, grid style or list) representing the current status of the result. The result event can also be compared to a predefined workflow and/or a set of business rules. For instance, if there is a business rule for the result event, evaluation of the business rule against the result event can trigger the display of an indication or visual icon representing the next step or operation that may be needed based on information from the result event. Also, if the current or prior business rule has already applied a previous indication or icon signaling the need for this result event, then the presence of the result event satisfies the prior indication or icon.

### Example #3

### Workflow for Non-Clinical Settings

In this example, an environmental services team that cleans rooms at a hospital can generate or otherwise transmit signal events. These signal events can be received and processed by certain embodiments of the system. These events can correspond to different rooms as the environmental services team progresses from rooms that need cleaning, to rooms being cleaned, to clean rooms which are ready for new patients. Indications, such as icons and room colors, can be generated to appear on at least one output device in at least one of the visual display formats (geospatial, grid style or list) representing the current status of each room. For example, an indication of brown colored rooms can be generated for rooms that are dirty and need cleaning, an indication of brown striped rooms can be generated for rooms that are being cleaned, and an indication of white colored rooms can be generated for rooms that are clean and ready for the patient.

One will recognize that the scope of the invention should not be limited to the above examples, and that many other example predefined workflows, business rules, and indications can exist in accordance with other embodiments of the invention.

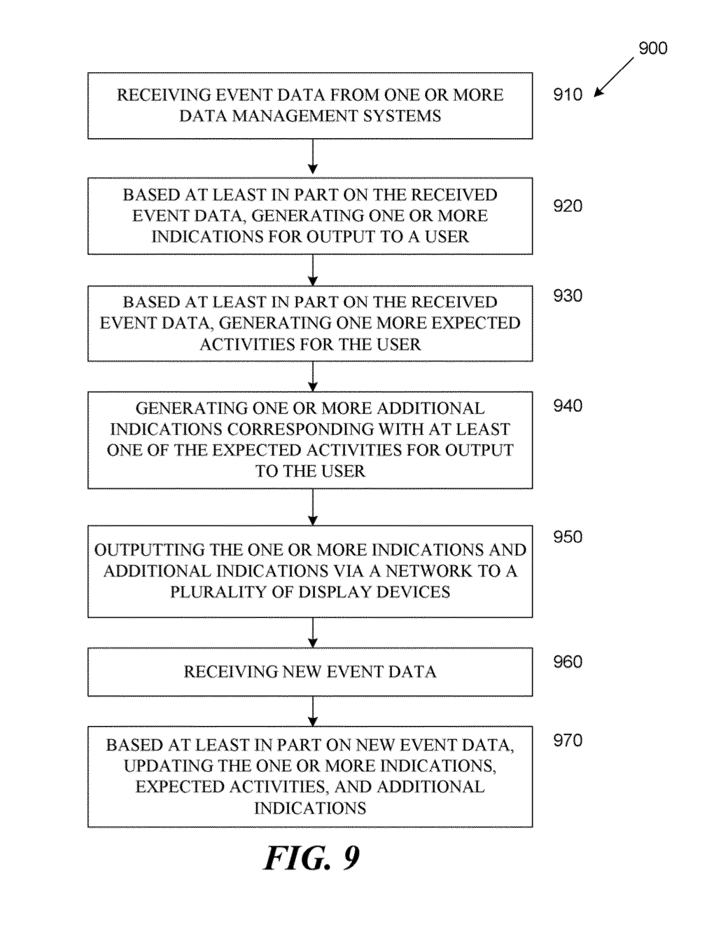

FIG. 9 represents an example method for providing enterprise visual communications. The method 900 can be implemented with certain embodiments of the invention, such as the system 100 in FIG. 1 and the data flows 200, 800 in FIGS. 2 and 8. One will recognize that other method embodiments can include similar or different elements and/or sequence, and a fewer or greater number of elements.

The method 900 in FIG. 9 begins at block 910 in which event data is received from one or more data management systems, wherein the data management systems comprise at least one of the following: a clinical system, an ADT system, an admission system, an environmental service system, an order and results system, a case management system, a transporter system, and a data system with event data associated with a patient care facility.

Block 910 is followed by block 920, in which based at least in part on the received event data, one or more indications are generated for output to a user, wherein received event data comprises at least one of the following: a real time event, data associated with a patient, and data associated with a patient care facility.

In one aspect of an embodiment, a respective visual indication can be output to a display device; and the respective visual indication can be organized on the display device, wherein the organization comprises at least one of the following: a scaled geospatial arrangement corresponding with a physical location, a grid, and a list.

In one aspect of an embodiment, a visual indication can include at least one of the following: an icon, a color, a background color, a timer, a rotating icon, a rotating timer, a label, and text.

Block 920 is followed by block 930, in which based at least in part on the received event data, one or more expected activities are generated for the user.

Block 930 is followed by block 940, in which one or more additional indications are generated corresponding with at least one of the expected activities for output to the user.

In one aspect of an embodiment, the received event data is compared to a predefined workflow, the predefined workflow including one or more activities; the received event data is compared to at least one threshold associated with an activity; and if the at least one threshold is met, exceeded, or otherwise satisfied, at least one expected activity is identified.

In one aspect of an embodiment, the received event data is compared to a predefined workflow, the predefined workflow including one or more activities compliant with at least one healthcare standard; and if the at least one healthcare standard is satisfied, at least one expected activity is identified.

Block 940 is followed by block 950, in which the one or more indications and additional indications are output via a network to a plurality of display devices.

Block 950 is followed by optional block 960, in which new event data is received.

Block 960 is followed by optional block 970, in which based at least in part on the new event data, at least one of the one or more indications, at least one of expected activities, and at least one of the one or more additional indications are updated.

The method 900 may end after block 970.

Accordingly, the example method illustrated in FIG. 9 can facilitate providing enterprise visual communications services.

Embodiments of the invention are described above with reference to block and flow diagrams of systems, methods, apparatuses, and/or computer program products according to example embodiments of the invention. It will be understood that one or more blocks of the block diagrams and flow diagrams, and combinations of blocks in the block diagrams and flow diagrams, respectively, can be implemented by computer-executable program instructions. Likewise, some blocks of the block diagrams and flow diagrams may not necessarily need to be performed in the order presented, or may not necessarily need to be performed at all, according to some embodiments of the invention.

These computer-executable program instructions may be loaded onto a general-purpose computer, a special-purpose computer, a processor, or other programmable data processing apparatus to produce a particular machine, such that the instructions that execute on the computer, processor, or other programmable data processing apparatus create means for implementing one or more functions specified in the flow diagram block or blocks. These computer program instructions may also be stored in a computer-readable memory that can direct a computer or other programmable data processing apparatus to function in a particular manner, such that the instructions stored in the computer-readable memory produce an article of manufacture including instruction means that implement one or more functions specified in the flow diagram block or blocks. As an example, embodiments of the invention may provide for a computer program product, comprising a computer-usable medium having a computer-readable program code or program instructions embodied therein, said computer-readable program code adapted to be executed to implement one or more functions specified in the flow diagram block or blocks. The computer program instructions may also be loaded onto a computer or other programmable data processing apparatus to cause a series of operational elements or steps to be performed on the computer or other programmable apparatus to produce a computer-implemented process such that the instructions that execute on the computer or other programmable apparatus provide elements or steps for implementing the functions specified in the flow diagram block or blocks.

Accordingly, blocks of the block diagrams and flow diagrams support combinations of means for performing the specified functions, combinations of elements or steps for performing the specified functions and program instruction means for performing the specified functions. It will also be understood that each block of the block diagrams and flow diagrams, and combinations of blocks in the block diagrams and flow diagrams, can be implemented by special-purpose, hardware-based computer systems that perform the specified functions, elements or steps, or combinations of special-purpose hardware and computer instructions.

It will be appreciated that each of the memories and data storage devices described herein can store data and information for subsequent retrieval. The memories and databases can be in communication with each other and/or other databases, such as a centralized database, or other types of data storage devices. When needed, data or information stored in a memory or database may be transmitted to a centralized database capable of receiving data, information, or data records from more than one database or other data storage devices. In other embodiments, the databases shown can be integrated or distributed into any number of databases or other data storage devices.

It will also be appreciated that each of the I/O interfaces described herein may facilitate communication between a processor and various I/O devices, such as a keyboard, mouse, printer, microphone, speaker, monitor, bar code readers/scanners, RFID readers, and the like. Likewise, each of the network interfaces described herein may take any of a number of forms, such as a network interface card, a modem, a wireless network card, and the like.

It will further be appreciated that while certain computers have been illustrated herein as a single computer or processor, the illustrated computers may actually be comprised of a group of computers or processors, according to an example embodiment of the invention.

Many modifications and other embodiments of the invention will come to mind to one skilled in the art to which this invention pertains and having the benefit of the teachings presented in the foregoing descriptions and the associated drawings. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for purposes of limitation.

1. A system, comprising:
at least one memory for storing computer-executable instructions; and
at least one processor configured to access the memory and further configured to execute the computer-executable instructions operable to:
receive event data from one or more data management systems;
based at least in part on the received event data, generate one or more indications for output to a user;
based at least in part on the received event data, generate one or more expected activities for the user; and
generate one or more additional indications corresponding with at least one of the expected activities for output to the user.

2. The system of claim 1, wherein the data management systems comprise at least one of the following: a clinical system, an ADT system, an admission system, an environmental service system, an order and results system, a case management system, a transporter system, and a data system with event data associated with a patient care facility.

3. The system of claim 1, wherein the event data comprises at least one of the following: a real time event, data associated with a patient, and data associated with a patient care facility.

4. The system of claim 1, wherein the computer-executable instructions operable to generate one or more indications for output to a user further comprise instructions operable to:
output a respective visual indication to a display device; and
organize the respective visual indication on the display device, wherein the organization comprises at least one of the following: a scaled geospatial arrangement corresponding with a physical location, a grid, and a list.

5. The system of claim 4, wherein the visual indication comprises at least one of the following: an icon, a color, a background color, a timer, a rotating icon, a rotating timer, a label, and text.

6. The system of claim 1, wherein the computer-executable instructions operable to generate one more expected activities for the user further comprise instructions operable to:
compare the received event data to a predefined workflow, the predefined workflow comprising one or more activities;
compare the received event data to at least one threshold associated with an activity; and
if the at least one threshold is met or exceeded, identify at least one expected activity.

7. The system of claim 1, wherein computer-executable instructions operable to generate one more expected activities for the user further comprise instructions operable to:
compare the received event data to a predefined workflow, the predefined workflow comprising one or more activities compliant with at least one healthcare standard; and
if the at least one healthcare standard is satisfied, identify at least one expected activity.

8. The system of claim 1, wherein the computer-executable instructions are further operable to:
receive new event data;
based at least in part on the new event data, update at least one of the one or more indications, at least one of the one or more expected activities, and at least one of the one or more additional indications.

9. The system of claim 1, the computer-executable instructions are further operable to:
output the one or more indications via a network to a plurality of display devices.

10. A method, comprising:
receiving event data from one or more data management systems;
based at least in part on the received event data, generating one or more indications for output to a user;
based at least in part on the received event data, generating one more expected activities for the user; and
generating one or more additional indications corresponding with at least one of the expected activities for output to the user.

11. The method of claim 10, wherein the event data comprises at least one of the following: a real time event, data associated with a patient, and data associated with a patient care facility.

12. The method of claim 10, wherein generating one or more indications for output to a user comprises:
outputting a respective visual indication to a display device; and
organizing the respective visual indication on the display device, wherein the organization comprises at least one of the following: a scaled geospatial arrangement corresponding with a physical location, a grid, and a list.

13. The method of claim 10, wherein generating one more expected activities for the user comprises:
comparing the received event data to a predefined workflow, the predefined workflow comprising one or more activities;
comparing the received event data to at least one threshold associated with an activity; and
if the at least one threshold is met or exceeded, identifying at least one expected activity.

14. The method of claim 10, wherein generating one or more expected activities for the user comprises:
comparing the received event data to a predefined workflow, the predefined workflow comprising one or more activities compliant with at least one healthcare standard;
if the at least one healthcare standard is satisfied, identifying at least one expected activity.

15. The method of claim 10, further comprising:
receiving new event data;
based at least in part on the new event data, updating at least one of the one or more indications, at least one of the expected activities, and at least one of the one or more additional indications.

16. The method of claim 10, further comprising:
outputting the one or more indications and additional indications via a network to a plurality of display devices.

17. A method, comprising:
receiving event data from one or more data management systems, wherein the data management systems comprise at least one of the following: a clinical system, an ADT system, an admission system, an environmental service system, an order and results system, a case management system, a transporter system, and a data system with event data associated with a patient care facility;
based at least in part on the received event data, generating one or more indications for output to a user, wherein received event data comprises at least one of the following: a real time event, data associated with a patient, and data associated with a patient care facility;
based at least in part on the received event data, generating one more expected activities for the user;
generating one or more additional indications corresponding with at least one of the expected activities for output to the user; and
outputting the one or more indications and additional indications via a network to a plurality of display devices.

18. The method of claim 17, wherein generating one or more indications for output to a user comprises:
outputting a respective visual indication to a display device; and
organizing the respective visual indication on the display device, wherein the organization comprises at least one of the following: a scaled geospatial arrangement corresponding with a physical location, a grid, and a list.

19. The method of claim 17, wherein generating one more expected activities for the user comprises:
comparing the received event data to a predefined workflow, the predefined workflow comprising one or more activities;
comparing the received event data to at least one threshold associated with an activity; and
if the at least one threshold is met or exceeded, identifying at least one expected activity.

20. The method of claim 17, further comprising:
receiving new event data;
based at least in part on the new event data, updating at least one of the one or more indications, at least one of expected activities, and at least one of the one or more additional indications.
